(19) United States
(12) Patent Application Publication
(10) Pub. No.: US 2015/0099590 A1
(43) Pub. Date: Apr. 9, 2015

(54) CLOUD SERVER AND METHOD FOR PROVIDING CLOUD GAME SERVICE

(71) Applicant: Electronics and Telecommunications Research Institute, Daejeon (KR)

(72) Inventors: Dongchun LEE, Daejeon (KR); Changsik CHO, Daejeon (KR); Hunjoo LEE, Daejeon (KR)

(21) Appl. No.: 14/454,616

(22) Filed: Aug. 7, 2014

(30) Foreign Application Priority Data
Oct. 4, 2013 (KR) 10-2013-0118520

(51) Int. Cl. H04L 29/08

(52) U.S. Cl. CPC H04L 67/12; H04L 67/10
USPC 463/42

(57) ABSTRACT

The present invention relates to a cloud server and method that automatically select a user interface script from among user interface scripts provided by a cloud game, generate a screen corresponding to the user interface script, and provide the screen to a client terminal user. The cloud server includes a user input unit for receiving a user input through a client terminal A script transmission unit transmits a list of user interface scripts of a game selected by a user corresponding to the user input to the client terminal A comparison unit compares an entire image of a screen of the game with previously stored image patterns. An ID transmission unit transmits an ID of a user interface script selected via results of a comparison to the client terminal, and allows the client terminal to generate a cloud screen using the ID of the user interface script.

### CROSS REFERENCE TO RELATED APPLICATION

This application claims the benefit of Korean Patent Application No. 10-2013-0118520, filed on Oct. 4, 2013, which is hereby incorporated by reference in its entirety into this application.

### BACKGROUND OF THE INVENTION

1. Technical Field

The present invention relates generally to a cloud server and method for providing a cloud game service and, more particularly, to a cloud server and method that automatically select a user interface script desired by a user from among a plurality of user interface scripts provided by a cloud game, generate a screen corresponding to the selected user interface script, and provide the generated screen to a client terminal user.

2. Description of the Related Art

As the environment of wired/wireless networks is improved, and the popularization of set-top boxes, smart phones, and mobile terminals has expanded with the rapid development of communication technology, requirements to play high-specification game content provided by a Personal Computer (PC) using such terminals have gradually increased.

A cloud game is a technology introduced to satisfy such requirements of users, and a game service is provided in such a way that a cloud server functions to perform all operations required by a game, generates a game screen, and streams the generated game screen to a client, and a client terminal functions to show a streamed game video to a user and transfer input signals entered by the user to the cloud server.

However, most PC games are configured to play a game by receiving a user input via a keyboard and a mouse, whereas most client terminals on which cloud games are executed are touch screen—based smart phones. Thus, a technology for converting a touch input made on such a smart phone into an input signal for the keyboard and the mouse is required.

In order to perform such input signal conversion, a conventional cloud game uses a method of creating a user interface script screen for receiving an input signal, combining the user interface script screen with a game screen transmitted from the server, and showing the combined results to a client terminal user.

Further, in order to generate the user interface script screen, the cloud game provides a plurality of user interface scripts and uses a method of providing different user interface script screens to the client terminal depending on the user's selection.

However, there is a disadvantage in that the user is required to personally change a user interface script screen while playing the game using the client terminal, thus decreasing immersion in the game.

### SUMMARY OF THE INVENTION

Accordingly, the present invention has been made keeping in mind the above problems occurring in the prior art, and an object of the present invention is to provide a cloud server and method that automatically select a user interface script desired by a user from among a plurality of user interface scripts provided by a cloud game, generate a screen corresponding to the selected user interface script, and provide the generated screen to a client terminal user.

In accordance with an aspect of the present invention to accomplish the above object, there is provided a method of providing a cloud game service, including transmitting, by a cloud server, a list of games to a client terminal; executing an application of a game selected by a user via the client terminal; transmitting a list of user interface scripts to be used in the game selected by the user to the client terminal; capturing a game screen corresponding to the application of the game; comparing an entire image of the captured game screen with previously stored image patterns, and selecting a user interface script based on results of a comparison; and transmitting an identifier (ID) of the selected user interface script to the client terminal, and then controlling the client terminal so that the client terminal is capable of generating a cloud screen using the ID of the user interface script.

Preferably, the list of user interface scripts is a list of user interface scripts corresponding to a user interface script screen to be used in the game selected by the user.

Preferably, selecting the user interface script may be configured to compare the entire image of the captured game screen with the previously stored image patterns, and select a user interface script corresponding to a matching pattern.

Preferably, each of the image patterns may include actual image data and image information.

Preferably, controlling may be configured such that the client terminal generates the cloud screen based on both a screen corresponding to the ID of the user interface script and a video stream, and provides the generated cloud screen to the user.

In accordance with another aspect of the present invention to accomplish the above object, there is provided a cloud server for providing a cloud game server, including a user input unit for receiving a user input through a client terminal; a script transmission unit for transmitting a list of user interface scripts of a game selected by a user corresponding to the user input to the client terminal; a comparison unit for comparing an entire image of a screen of the game with previously stored image patterns; and an identifier (ID) transmission unit for transmitting an ID of a user interface script selected via results of a comparison by the comparison unit to the client terminal, and allowing the client terminal to generate a cloud screen using the ID of the user interface script.

Preferably, the list of user interface scripts may be a list of user interface scripts corresponding to a user interface script screen to be used in the game selected by the user.

Preferably, the previously stored image patterns may be separately stored in an image pattern database including image patterns to be used for respective games and user interface scripts corresponding to the image patterns.

Preferably, the ID transmission unit may select a user interface script corresponding to a matching pattern as the results of the comparison between the entire image of the game screen and the previously stored image patterns by the comparison unit, and transmit the ID of the selected user interface script.

Preferably, when the ID transmission unit transmits the ID of the user interface script to the client terminal, the client terminal may generate the cloud screen based on both a screen corresponding to the ID of the user interface script and a video stream, and provide the generated cloud screen to the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an environment in which a cloud game service is provided according to an embodiment of the present invention;

FIG. 2 is a diagram schematically showing the configuration of a cloud server and a client terminal in the environment in which the cloud game service is provided according to an embodiment of the present invention;

FIG. 3 is a diagram showing image patterns to be used for respective games and user interface scripts corresponding to the image patterns according to an embodiment of the present invention;

FIG. 4 is a diagram showing resulting screens for respective principal stages of a WoW game in a WoW game service to which the cloud game service is applied according to an embodiment of the present invention;

FIG. 5 is a flowchart showing a method of providing a cloud game service from the standpoint of a cloud server according to an embodiment of the present invention;

FIG. 6 is a flowchart showing a method of providing a cloud game service from the standpoint of a client terminal according to an embodiment of the present invention; and

FIG. 7 is an embodiment of the present invention implemented in a computer system.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, a cloud server and method for providing a cloud game service according to preferred embodiments of the present invention will be described in detail with reference to the attached drawings.

First, a cloud game is configured to serve a single game application to various terminals, and thus a game interface provided by a client terminal is greatly different from an interface supported by the game application. In order to solve a problem occurring due to a difference between the interfaces, the cloud game service is configured to generate a cloud game video by additionally overlaying a user interface screen required to receive an input from a user on a game screen.

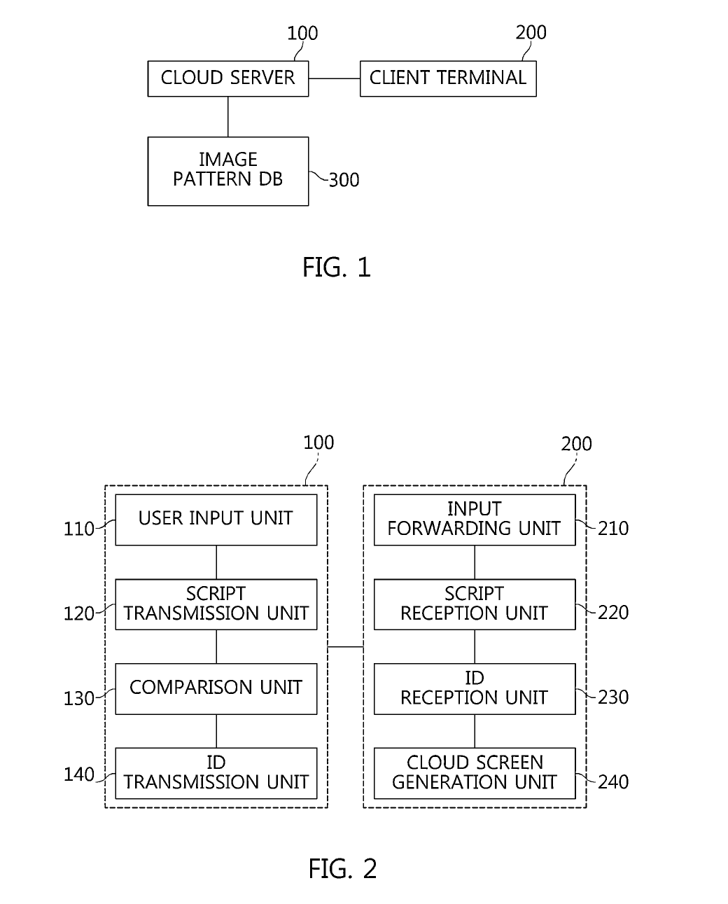

FIG. 1 is a diagram showing an environment in which a cloud game service is provided according to an embodiment of the present invention.

Referring to FIG. 1, in the environment in which the cloud game service is provided, a cloud server 100, a client terminal 200, and an image pattern database (DB) 300 are located.

The cloud server 100 captures a game screen, compares the captured game screen with image patterns of the image pattern DB 300, and transmits the user interface script identifier (ID) of a pattern corresponding to the results of the comparison to the client terminal 200.

The client terminal 200 automatically generates a cloud screen based on the game screen and the user interface script ID received from the cloud server 100.

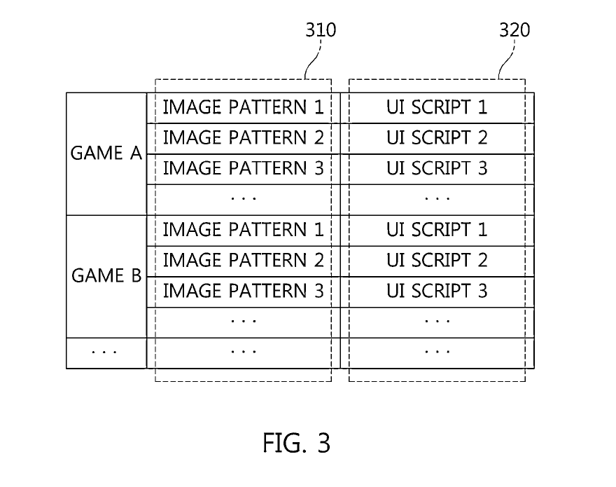

As shown in FIG. 3, the image pattern DB 300 includes image patterns (image pattern 1, image pattern 2, image pattern 3, etc.) 310 to be used for each game, and user interface scripts (UI script 1, UI script 2, UI script 3, etc.) 320 corresponding to the image patterns.

Below, the detailed configuration and function of the cloud server 100 and the client terminal 200 will be described in detail with reference to FIG. 2.

FIG. 2 is a diagram schematically showing the configuration of a cloud server and a client terminal in the environment in which the cloud game service is provided according to an embodiment of the present invention.

Referring to FIG. 2, the cloud server 100 includes a user input unit 110, a script transmission unit 120, a comparison unit 130, and an ID transmission unit 140.

The user input unit 110 receives a user input through the client terminal 200.

The script transmission unit 120 transmits a list of user interface (also referred to as “UI”) scripts (for example, UI script 1, UI script 2, UI script 3, etc.) of a game selected by a user corresponding to the user input to the client terminal 200. Here, the UI script list denotes a list of UI scripts corresponding to a UI script screen 1200 to be in the game selected by the user.

The comparison unit 130 compares the screen of the game corresponding to the user input, that is, a game screen, with image patterns stored in the image pattern DB 300, and searches for a UI script corresponding to an image pattern matching the game screen.

The ID transmission unit 140 transmits a UI script ID corresponding to the index number of the UI script, found as the results of the comparison by the comparison unit 130, to the client terminal 200.

Thereafter, the client terminal 200 generates a cloud screen by overlaying a screen corresponding to the UI script ID on a video stream received from the cloud server 100.

For this, the client terminal 200 includes an input forwarding unit 210, a script reception unit 220, an ID reception unit 230, and a cloud screen generation unit 240.

The input forwarding unit 210 receives an input signal from the user and forwards the input signal to the cloud server 100.

The script reception unit 220 receives a list of UI scripts from the cloud server 100.

The ID reception unit 230 receives a UI script ID from the cloud server 100.

The cloud screen generation unit 240 generates a cloud screen based on the screen corresponding to the received UI script ID and the video stream, and provides the generated cloud screen to the user.

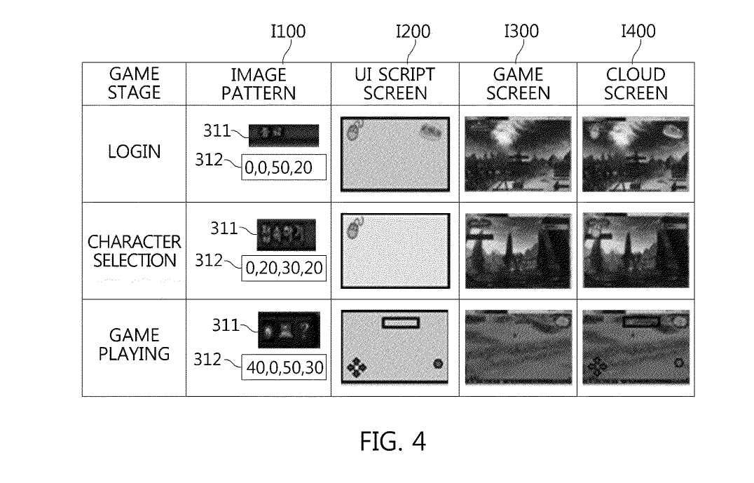

Then, the cloud server for providing a cloud game service according to the embodiment of the present invention is applied to a World of Warcraft (WoW) game service, and the results of respective principal stages of the game corresponding to the results of the application will be described in detail with reference to FIG. 4.

FIG. 4 is a diagram showing resulting screens for respective principal stages of a WoW game in a WoW game service to which the cloud game service is applied according to an embodiment of the present invention.

Referring to FIG. 4, the WoW game enters an actual game play stage after passing through a login stage and a character selection stage.

Since the login stage must be configured to receive the ID and password of a user, both a mouse and a keyboard must be used.

The character selection stage is the stage of selecting a character to play the game from among a plurality of characters, and requires only a mouse-based input.

The game play stage is configured to use a keyboard-based input, but only four important keys related to the movement of the character are manly used without all keys of the keyboard being used.

The cloud server for providing the cloud game service according to the embodiment of the present invention is configured to reflect the characteristics of respective stages of the WoW game, to generate UI scripts, and cause the UI scripts to be managed by the image pattern DB 300.

Referring to FIG. 4, an image pattern I100 corresponding to each UI script includes actual image data 311 and image information 312. The image information 312 is simply composed of a start position (x, y) of an image and the size (x, y) of the image.

A UI script screen I200 is an example of a form in which the UI script is displayed as a resulting screen, and a game screen I300 is an example of a screen in which the screen of a game executed on the cloud server 100 is captured.

Further, a cloud screen I400 is an example of a final video displayed to the user via the client terminal 200.

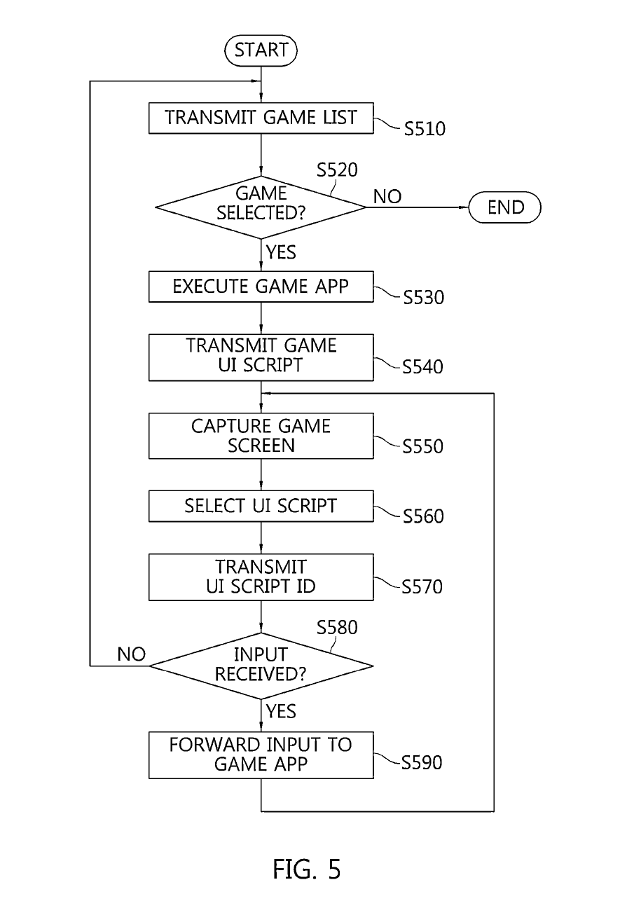

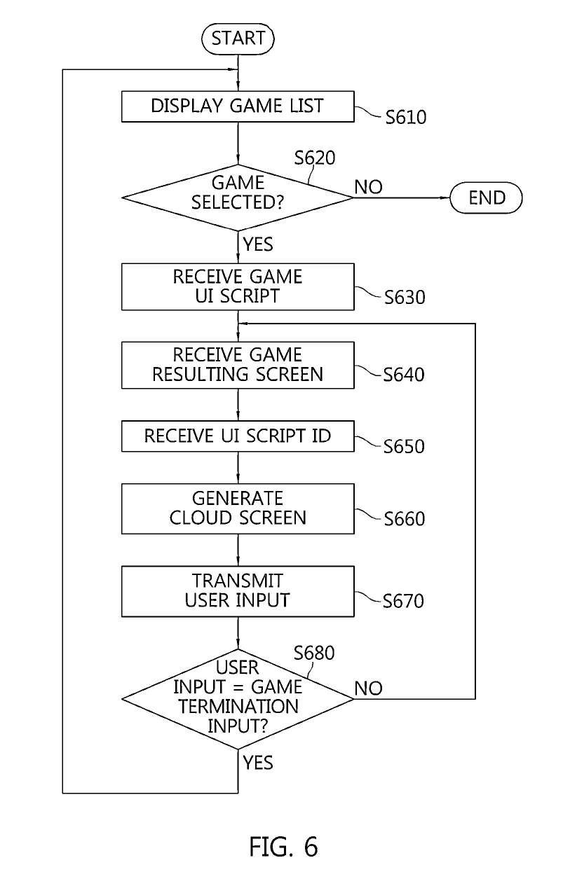

Below, methods of providing a cloud game service from the standpoint of the cloud server and the client terminal will be described in detail with reference to FIGS. 5 and 6.

FIG. 5 is a flowchart showing a method of providing a cloud game service from the standpoint of the cloud server according to an embodiment of the present invention.

Referring to FIG. 5, when the client terminal 200 accesses the cloud server 100, the cloud server 100 transmits a list of games provided thereby to the client terminal 200 at step S510.

Next, the cloud server 100 determines which of the games has been selected by a user via the client terminal 200 at step S520. In this case, when the user makes an input corresponding to service termination rather than a game selection input, the service is terminated.

When the game selection input is received, the cloud server 100 executes a game application (App) corresponding to the input at step S530.

The cloud server 100 transmits a list of UI scripts (for example, UI script 1, UI script 2, UI script 3, etc.) to be used in the game selected by the user to the client terminal 200 at step S540. Here, the UI script list denotes a list of UI scripts corresponding to the UI script screen I200 to be used in the game selected by the user.

The cloud server 100 captures a game screen corresponding to the game application executed at step S530 in real time at step S550.

The cloud server 100 compares the entire image of the game screen captured at step S550 with the image patterns stored in the image pattern DB 300, and selects a UI script corresponding to a matching pattern at step S560.

The cloud server 100 transmits a UI script ID corresponding to the index number of the UI script selected at step S560 to the client terminal 200 at step S570.

The cloud server 100 transmits the UI script ID to the client terminal 200, and determines whether an input corresponding to the UI script ID, for example, an input related to the game, has been received at step S580.

If the input is an input value requesting the termination of the service rather than the input related to the game, the cloud server 100 returns to step S510 of transmitting the game list to the client terminal 200. In contrast, if the input is related to the game, the cloud server 100 forwards the input to the game App at step S590, and re-performs the procedure starting from step S550.

In this way, the present invention may be configured such that all operations related to the cloud game service are performed by the cloud server 100, and only the resulting screens of the game are streamed to the client terminal 200, thus providing a cloud game service that enables high-specification games to be played even on low-specification terminals. That is, the present invention provides technology for monitoring variations in a game screen in real time and then automatically switching a user interface screen for user input.

FIG. 6 is a flowchart showing a method of providing a cloud game service from the standpoint of the client terminal according to an embodiment of the present invention.

Referring to FIG. 6, after accessing the cloud server 100, the client terminal 200 receives a list of games from the cloud server 100, and displays the received game list to the user at step S610.

The client terminal 200 determines whether the user has selected a game from the game list, provided to the user at step S610, at step S620.

If it is determined at step S620 that a received input signal is a service termination signal rather than a game selection input signal, the client terminal 200 forwards the input signal to the cloud server 100 and then terminates the service.

In contrast, if it is determined at step S620 that the received input signal is the game selection input signal, the client terminal 200 forwards the input signal to the cloud server 100, and receives a list of UI scripts to be used in the game selected by the user from the cloud server 100 at step S630. Here, the UI script list denotes a list of UI scripts corresponding to a UI script screen I200 to be used in the game selected by the user.

The client terminal 200 receives a game screen I300 executed on the cloud server 100 via network communication at step S640.

The client terminal 200 receives a UI script ID corresponding to the index number of a UI script to be generated on the game screen I300, received at step S640, at step S650.

The client terminal 200 generates a cloud screen I400 based on a UI script screen I200 corresponding to the UI script ID on the game screen, received at step S640, at step S660. The client terminal 200 displays the generated cloud screen I400 to the user.

The client terminal 200 receives a user input via the cloud screen generated at step S660 and transmits the user input to the cloud server 100 at step S670.

The client terminal 200 determines whether the user input received at step S670 is an input corresponding to the termination of the game at step S680.

If the user input is an input corresponding to the game termination, the client terminal 200 performs the game termination step and then returns to step S610 where the game list is displayed to the user. In contrast, if the user input does not correspond to game termination, the client terminal 200 returns to step S640 where a new game screen is received from the cloud server 100 via network communication.

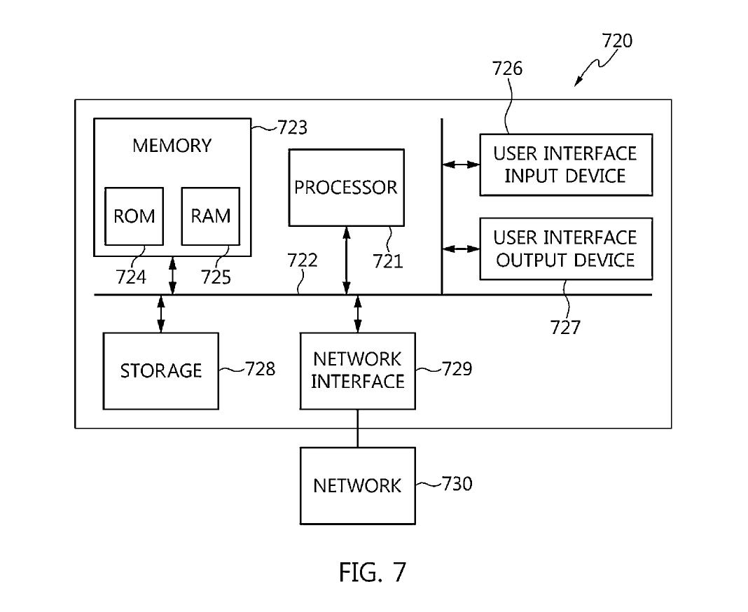

FIG. 7 is an embodiment of the present invention implemented in a computer system. Referring to FIG. 7, an embodiment of the present invention may be implemented in a computer system, e.g., as a computer readable medium. As shown in in FIG. 7, a computer system 720 may include one or more of a processor 721, a memory 723, a user interface input device 726, a user interface output device 727, and a storage 728, each of which communicates through a bus 722. The computer system 720 may also include a network interface 729 that is coupled to a network 730. The processor 721 may be a central processing unit (CPU) or a semiconductor device that executes processing instructions stored in the memory 723 and/or the storage 728. The memory 723 and the storage 728 may include various forms of volatile or non-volatile storage media. For example, the memory may include a read-only memory (ROM) 724 and a random access memory(RAM) 725.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

In accordance with the present invention, the cloud server and method for providing a cloud game service can automatically update game user interface scripts that are provided to solve the problem of user input processing that occurs due to a difference between a user input device used by a client terminal and an input device used by a game application executed on a cloud server, upon executing a cloud game service.

Further, the present invention allows gamers to be further immersed in their games via technology for automatically updating user interface scripts.

Furthermore, the present invention may set image patterns to be used in respective games and user interface scripts required to configure a user interface script screen for respective users, thus enabling user-customized user interface scripts to be automatically updated.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A method of providing a cloud game service, comprising:
transmitting, by a cloud server, a list of games to a client terminal;
executing an application of a game selected by a user via the client terminal;
transmitting a list of user interface scripts to be used in the game selected by the user to the client terminal;
capturing a game screen corresponding to the application of the game;
comparing an entire image of the captured game screen with previously stored image patterns, and selecting a user interface script based on results of a comparison; and
transmitting an identifier (ID) of the selected user interface script to the client terminal, and then controlling the client terminal so that the client terminal is capable of generating a cloud screen using the ID of the user interface script.

2. The method of claim 1, wherein the list of user interface scripts is a list of user interface scripts corresponding to a user interface script screen to be used in the game selected by the user.

3. The method of claim 1, wherein selecting the user interface script is configured to compare the entire image of the captured game screen with the previously stored image patterns, and select a user interface script corresponding to a matching pattern.

4. The method of claim 3, wherein each of the image patterns includes actual image data and image information.

5. The method of claim 1, wherein controlling is configured such that the client terminal generates the cloud screen based on both a screen corresponding to the ID of the user interface script and a video stream, and provides the generated cloud screen to the user.

6. A cloud server for providing a cloud game server, comprising:
a user input unit for receiving a user input through a client terminal;
a script transmission unit for transmitting a list of user interface scripts of a game selected by a user corresponding to the user input to the client terminal;
a comparison unit for comparing an entire image of a screen of the game with previously stored image patterns; and
an identifier (ID) transmission unit for transmitting an ID of a user interface script selected via results of a comparison by the comparison unit to the client terminal, and allowing the client terminal to generate a cloud screen using the ID of the user interface script.

7. The cloud server of claim 6, wherein the list of user interface scripts is a list of user interface scripts corresponding to a user interface script screen to be used in the game selected by the user.

8. The cloud server of claim 6, wherein the previously stored image patterns are separately stored in an image pattern database including image patterns to be used for respective games and user interface scripts corresponding to the image patterns.

9. The cloud server of claim 6, wherein the ID transmission unit selects a user interface script corresponding to a matching pattern as the results of the comparison between the entire image of the game screen and the previously stored image patterns by the comparison unit, and transmits the ID of the selected user interface script.

10. The cloud server of claim 6, wherein, when the ID transmission unit transmits the ID of the user interface script to the client terminal, the client terminal generates the cloud screen based on both a screen corresponding to the ID of the user interface script and a video stream, and provides the generated cloud screen to the user.
